(19) United States
(12) Patent Application Publication
(10) Pub. No.: US 2017/0243613 A1
(43) Pub. Date: Aug. 24, 2017

(54) IMAGE PROCESSING APPARATUS THAT PROCESSES A GROUP CONSISTING OF A PLURALITY OF IMAGES, IMAGE PROCESSING METHOD, AND STORAGE MEDIUM

(71) Applicant: CASIO COMPUTER CO., LTD., Tokyo (JP)

(72) Inventors: Kazuto YAMAMOTO, Tokyo (JP); Shohei SAKAMOTO, Tokyo (JP); Kanako NAKANO, Tokyo (JP); Jun MURAKI, Tokyo (JP)

(73) Assignee: CASIO COMPUTER CO., LTD., Tokyo (JP)

(21) Appl. No.: 15/589,249

(22) Filed: May 8, 2017

Related U.S. Application Data
(63) Continuation of application No. 14/192,584, filed on Feb. 27, 2014.

(30) Foreign Application Priority Data
Mar. 22, 2013 (JP) 2013-059643

(51) Int. Cl. G11B 27/10; G11B 27/34

(52) U.S. Cl. CPC G11B 27/102; G11B 27/34

(57) ABSTRACT

An image processing apparatus includes a display and a CPU that is configured to: select, as a group, a plurality of moving images as a group of target moving images to be played back simultaneously or in sequence; specify a plurality of spatial or temporal playback relationships for playing back the group of target moving images simultaneously or in sequence; generate a plurality of groups of thumbnails representing the plurality of specified spatial or temporal playback relationships, such that each group of thumbnails includes one thumbnail corresponding to each of the target moving images to be played back, and such that each group of thumbnails visually represents a respective one of the specified the spatial or temporal playback relationships; and display the plurality of groups of thumbnails representing the plurality of specified spatial or temporal playback relationships.

This application is a Continuation application of U.S. Ser. No. 14/192,584, filed Feb. 27, 2014, which is based on and claims the benefit of priority from Japanese Patent Application No. 2013-059643, filed on Mar. 22, 2013, the content of both of which is incorporated herein by reference.

### BACKGROUND OF THE INVENTION

### Field of the Invention

The present invention relates to an image processing apparatus, an image processing method, and a storage medium.

### Related Art

Conventionally, a technology is disclosed which allows two images including an image of a form by a user himself/herself in sports such as a swing form of golf, tennis, and baseball and an image of a form as a model image by a professional to be arranged to be displayed in a comparable manner (hereinafter, referred to as “two screen display”) (for example, refer to Japanese Unexamined Patent Application, Publication, No. 2007-313362).

### SUMMARY OF THE INVENTION

An image processing apparatus according to a first aspect of the present invention includes: an image selection section that selects, as a group, a plurality of images as targets for predetermined processing; a thumbnail generation section that generates a thumbnail that can identify the group consisting of a plurality of images that is selected by the image selection section; an association section that associates predetermined information indicating the group consisting of a plurality of images selected by the image selection section with the thumbnail generated by the thumbnail generation section; and an execution section that, in response to an operation on the thumbnail associated by the association section, executes predetermined processing by automatically selecting a group consisting of a plurality of images indicated with predetermined information that is associated with the thumbnail.

An image processing method according to a second aspect of the present invention is an image processing method executed by an image processing apparatus executing predetermined processing, includes: an image selection step of selecting, as a group, a plurality of images as targets for predetermined processing; a thumbnail generation step of generating a thumbnail that can identify the group consisting of a plurality of images that is selected by the image selection step; an association step of associating predetermined information indicating the group consisting of a plurality of images selected by the image selection step with the thumbnail generated by the thumbnail generation step; and an execution step of executing, in response to an operation on the thumbnail associated by the association step, predetermined processing by automatically selecting a group consisting of a plurality of images indicated with predetermined information that is associated with the thumbnail.

A computer-readable storage medium according to a third aspect of the present invention is a non-transitory storage medium encoded with a computer-readable program that enables a computer to execute: an image selection function that selects, as a group, a plurality of images as targets for predetermined processing; a thumbnail generation function that generates a thumbnail that can identify the group consisting of a plurality of images that is selected by the image selection function; an association function that associates predetermined information indicating the group consisting of a plurality of images selected by the image selection function with the thumbnail generated by the thumbnail generation function; and an execution function that, in response to an operation on the thumbnail associated by the association function, executes predetermined processing by automatically selecting a group consisting of a plurality of images indicated with predetermined information that is associated with the thumbnail.

An image processing apparatus according to a fourth aspect of the present invention includes: a selection section that selects a group of spatial or temporal positional relationships consisting of a plurality of images as targets for predetermined processing; a thumbnail generation section that generates a thumbnail that can identify the group of spatial or temporal positional relationships consisting of a plurality of images selected by the selection section; an association section that associates predetermined information indicating the group of spatial or temporal positional relationships consisting of a plurality of images selected by the image selection section with the thumbnail generated by the thumbnail generation section; and an execution section that, in response to an operation on the thumbnail associated by the association section, executes predetermined processing by automatically selecting the group of spatial or temporal positional relationships consisting of a plurality of images indicated with predetermined information that is associated with the thumbnail.

An image processing method according to a fifth aspect of the present invention is an image processing method executed by an image processing apparatus executing predetermined processing, comprising: a selection step of selecting a group of spatial or temporal positional relationships consisting of a plurality of images as targets for predetermined processing; a thumbnail generation step of generating a thumbnail that can identify the group of spatial or temporal positional relationships consisting of a plurality of images selected by the selection step; an association step of associating predetermined information indicating the group of spatial or temporal positional relationships consisting of a plurality of images selected by the image selection step with the thumbnail generated by the thumbnail generation step; and an execution step of executing, in response to an operation on the thumbnail associated by the association step, predetermined processing by automatically selecting the group of spatial or temporal positional relationships consisting of a plurality of images indicated with predetermined information that is associated with the thumbnail.

A computer-readable storage medium according to a sixth aspect of the present invention is a non-transitory storage medium encoded with a computer-readable program that enables a computer to execute: a selection function that selects a group of spatial or temporal positional relationships consisting of a plurality of images as targets for predetermined processing; a thumbnail generation function that generates a thumbnail that can identify the group of spatial or temporal positional relationships consisting of a plurality of images selected by the selection function; an association function that associates predetermined information indicating the group of spatial or temporal positional relationships consisting of a plurality of images selected by the image selection function with the thumbnail generated by the thumbnail generation function; and an execution function that, in response to an operation on the thumbnail associated by the association function, executes predetermined processing by automatically selecting the group of spatial or temporal positional relationships consisting of a plurality of images indicated with predetermined information that is associated with the thumbnail.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a hardware configuration of an image processing device according to an embodiment of the present invention;

FIG. 2 is a functional block diagram showing a functional configuration for executing thumbnail register processing and replay processing among functional configurations of the image processing apparatus of FIG. 1;

FIG. 3 is a schematic view showing a specific example of an association of a pair of replay target moving images selected with a pair of thumbnails by the image processing apparatus of FIG. 2;

FIG. 4 is a schematic view illustrating an example of display of a pair of thumbnails on which the association of a spatial positional relationship is performed by the image processing apparatus of FIG. 2;

FIG. 5 is a schematic view illustrating that two screen simultaneous replay is performed for a pair of replay target moving images by the image processing apparatus of FIG. 2;

FIG. 6 is a schematic view illustrating an example of display of a pair of thumbnails on which association of a temporal positional relationship is performed by the image processing apparatus of FIG. 2;

FIG. 7 is a schematic view showing actual displays of a pair of thumbnails for each of spatial or temporal positional relationship;

FIG. 8 is a flowchart showing a flow of the thumbnail register processing of a first embodiment executed by the image processing apparatus having the functional configuration of FIG. 2;

FIG. 9 is a flowchart showing a flow of replay processing executed by the image processing apparatus having the functional configuration of FIG. 2;

FIG. 10 is a flowchart showing a flow of thumbnail register processing according to a second embodiment executed by the image processing apparatus having the functional configuration of FIG. 2; and

FIG. 11 is a flowchart showing a flow of thumbnail register processing according to a third embodiment executed by the image processing apparatus having the functional configuration of FIG. 2.

### DETAILED DESCRIPTION OF THE INVENTION

In the following, embodiments of the present invention are explained with reference to the drawings.

### First Embodiment

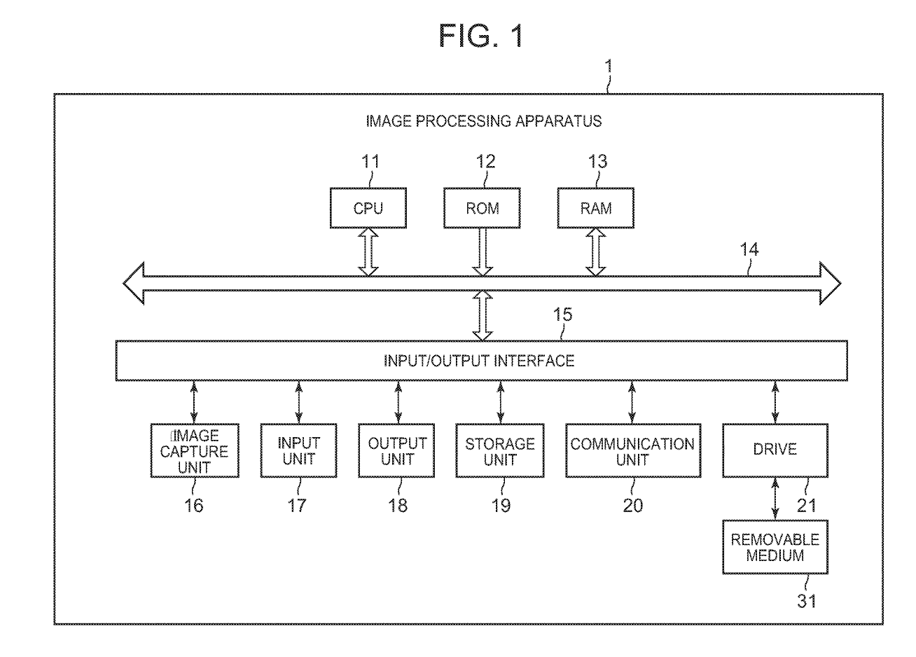

FIG. 1 is a block diagram showing a hardware configuration 1 of an image processing device according to an embodiment of the present invention.

The image processing device 1 is configured as, for example, a digital camera.

The image processing device 1 includes a CPU (Central Processing Unit) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 captures a subject and supplies a digital signal (image signal) of an image including a figure of the subject (hereinafter, referred to as “captured image”) to the CPU 11. Here, the digital signal of a captured image (image signal) is referred to as “data of a captured image” as appropriate.

The input unit 17 is configured by various buttons and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

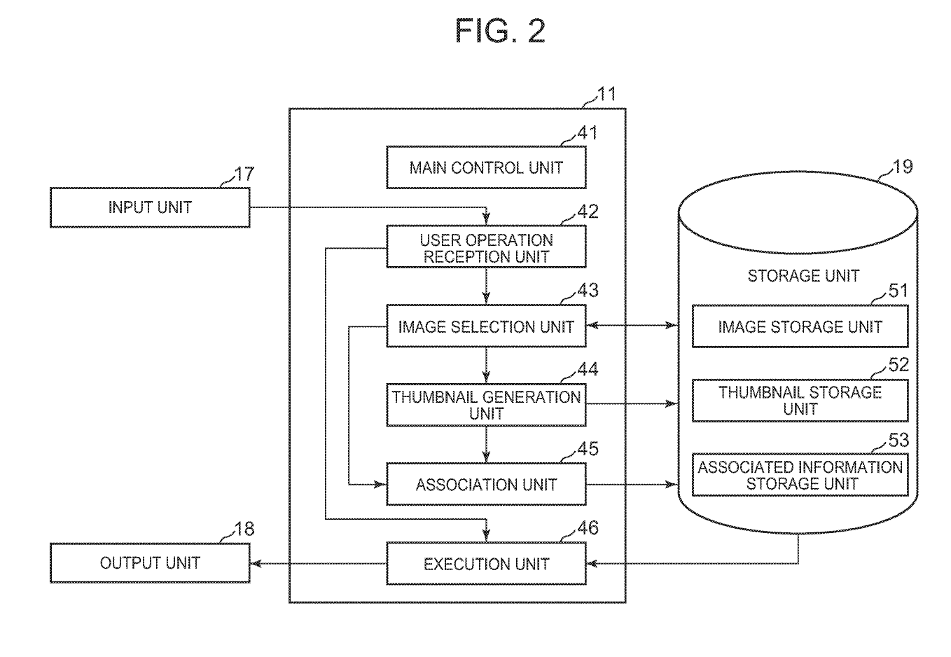

FIG. 2 is a functional block diagram showing a functional configuration for executing thumbnail register processing and replay processing among functional configurations of the image processing apparatus 1.

Here, the thumbnail register processing refers to the following sequence of processing.

In the present embodiment, a replay target is two moving images in which a motion of a certain person (for example, a user of the image processing apparatus 1 or a professional golfer, for the purpose of illustration) swinging a golf club is showing. Hereinafter, such moving images are referred to as “replay target moving image”. In other words, in the present embodiment, a two screen simultaneous replay is performed in which two replay target moving image are arranged in parallel, or a sequential replay is performed in which one moving image is replayed after the other moving image is replayed.

In order to determine a display form of the two screen simultaneous replay or the sequential replay, it is necessary for a user to perform an operation so as to designate two replay target moving images and further designate a spatial or temporal arrangement upon displaying these two replay target moving images. However, it would be expedient to save user's operations accompanied with various designations for the two replay target moving images before the two screen simultaneous replay or the sequential replay is performed. More specifically, it would be expedient to save user's operations in a case in which the two screen simultaneous replay or the sequential replay is repeatedly executed multiple times.

In this regard, in the present embodiment, the image processing apparatus 1 is configured to: select a coupling (pair) of two replay target moving images designated by a user's operation; generate each of data sets of a pair of thumbnails corresponding to a pair of replay target moving images; and cause each of data sets of the pair of thumbnails to be stored (registered) in the storage unit 19 upon associating the pair of the replay target moving images with the pair of thumbnails. The image processing apparatus 1 is further configured to: for each of combinations (patterns) of the spatial or temporal arrangements upon a pair of replay target moving images being replayed, associate a combination with a pair of thumbnails. Such a sequence of processing is hereinafter referred to as “thumbnail registration processing”.

Furthermore, the image processing apparatus 1 displays the pair of thumbnails associated with the pair of replay target moving images for each of a plurality of combinations (patterns) of the spatial or temporal arrangements in such a form that the combination can be visually recognized by a user. The user performs an operation to designate the pair of thumbnails associated with a desirable combination from among the plurality of combinations (patterns) of the spatial or temporal arrangements while the user visually recognizes display contents. The image processing apparatus 1 recognizes contents operated and selects the pair of replay target moving images associated with the pair of thumbnails designated by the user. Then, the image processing apparatus 1 replays the pair of the replay target moving images with the spatial or temporal arrangement associated with the pair of thumbnails designated by the user. Such a sequence of processing is hereinafter referred to as “replay processing”.

When such the thumbnail registration processing and the replay processing are executed and controlled, as shown in FIG. 2, in the CPU 11, a main control unit 41, a user operation reception unit 42, an image selection unit 43, a thumbnail generation unit 44, an association unit 45, and an execution unit 46.

As an area of the storage unit 19, an image storage unit 51, a thumbnail storage unit 52, and an associated information storage unit 53 are provided.

In the image storage unit 51, data of a plurality of moving images as candidates for a replay target moving image is stored in advance. Data of the moving images stored in the image storage unit 51 may be data of moving images captured by the image capture unit 16 or may be data of images transmitted from another apparatus (not shown) and received by the communication unit 20.

In the thumbnail storage unit 52, data of thumbnails generated by the thumbnail generation unit 44 (described later) is stored. In the associated information storage unit 53 (described later), first association information and second association information generated by the association unit 45 are stored. The first association information and the second association information are described later.

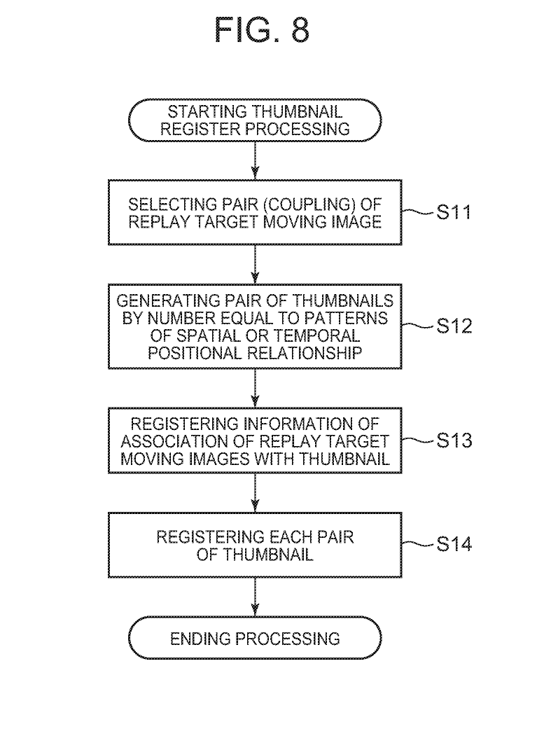

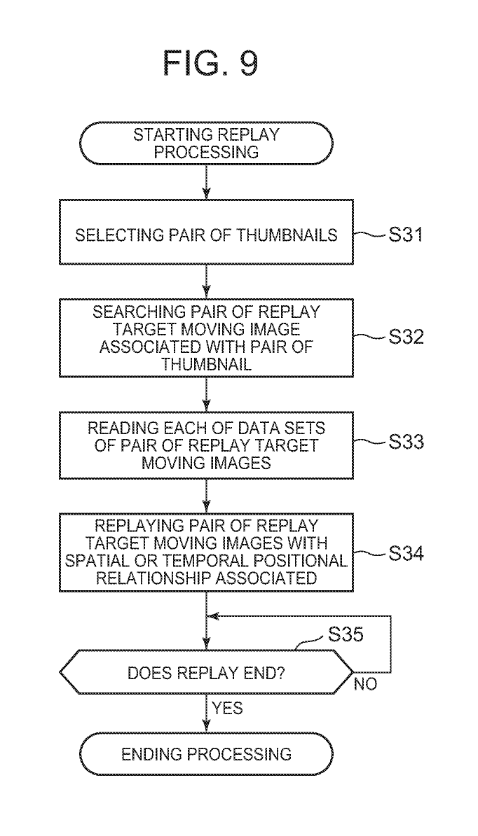

The main control unit 41 executes the overall control over the image processing apparatus 1, more specifically, various control accompanied with the thumbnail registration processing of FIG. 8 the replay processing of FIG. 9 described later.

The user operation reception unit 42 receives an operation by the user on the input unit 17.

For example, the user operates the input unit 17 to designate a pair of replay target moving image data from among a plurality of moving image data sets stored in the image storage unit 51 (here, a pair consisting of two replay target moving images). In this case, the user operation reception unit 42 receives a designation result therefrom.

The image selection unit 43 selects a pair of replay target moving images from among the plurality of moving image data stored in the image storage unit 51 based on contents operated by the user received by the user operation reception unit 42.

The thumbnail generation unit 44 generates each of data sets of a pair of the thumbnails corresponding to a pair of the replay target moving images selected by the image selection unit 43.

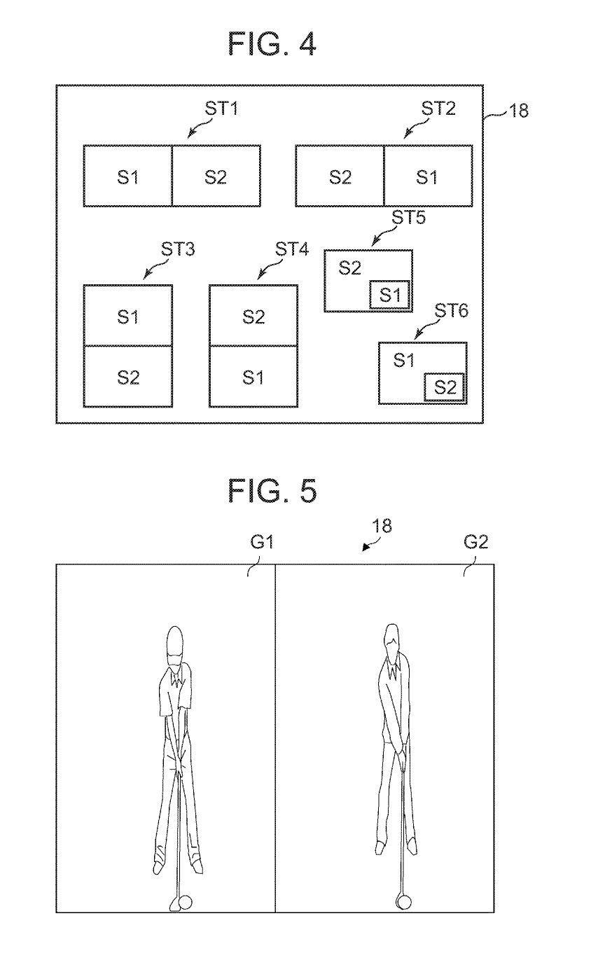

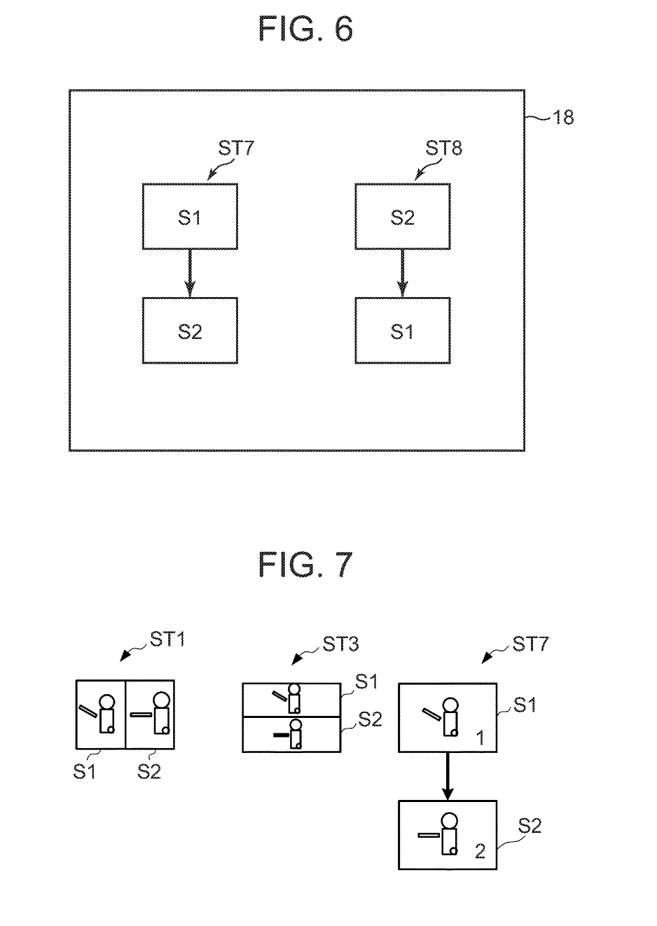

The thumbnail of the replay target moving image refers to an image with lower quality than that of the replay target moving image so long as the replay target moving image can be identified. In other words, the thumbnail is acceptable as an image with an image quality lower than that of the replay target moving image and may be a moving image for which some frames are thinned by a predetermined interval or a static image corresponding to a predetermined frame. However, in the present embodiment, as shown in FIG. 4 or 6, since a plurality of pairs of thumbnails is displayed on a single screen of the display of the output unit 18, a moving image in which the resolution of each frame is reduced (reduced image) is adopted as a thumbnail.

Furthermore, as described later with reference to FIG. 4, as a display form of a pair of thumbnails, a form is adopted in which a plurality of thumbnails (here, two thumbnails) belonging to the pair are spatially arranged in a vertical or horizontal direction so as to be displayed on an overall screen. Therefore, in order to allow for such a display, the thumbnail generation unit 44 changes the aspect ratio of the replay target moving image to generate some sets of data of thumbnails with lower resolution. In other words, the thumbnail generation unit 44 generates data of each thumbnail in a manner such that a plurality (here, two) of thumbnails can be displayed while maintaining a predetermined spatial or temporal positional relationship on a single screen of the display of the output unit 18.

Here, the spatial positional relationship refers to a positional relationship in which two images are arranged spatially. The spatial positional relationship includes, for example, a relationship in which the two images are arranged vertically, horizontally, or diagonally, a relationship in which the two images are arranged so as to be spaced apart with a predetermined interval, or a relationship in which the two images are arranged to be superimposed.

Furthermore, the temporal positional relationship refers to a positional relationship in which two images are arranged alongside on a temporal axis upon replay.

The temporal positional relationship includes, for example, a relationship of a replay time of two images that are replayed sequentially temporally. To sum up, the thumbnail generation unit 44 generates data of pairs of the thumbnails corresponding to pairs of the replay target moving images selected by the image selection unit 43 by the number equal to patterns of replay form of the pairs of replay target moving images (patterns of the spatial or temporal positional relationship described later). For example, in a case of the pattern in which two replay target moving images are arranged horizontally and the two screen simultaneous replay is performed, each of data sets of a pair of two thumbnails (refer to a pair ST1 of FIG. 7 described later) is generated in which the aspect ratio is changed so as to reduce the ratio in the horizontal direction. On the other hand, in a case of the pattern in which the two replay target moving images are arranged vertically and the two screen simultaneous replay is performed, each of data sets of the pair of tow thumbnails (refer to a pair ST3 of FIG. 7 described later) is generated in which the aspect ratio of changed so as to reduce the ratio in the vertical direction.

The thumbnail generation unit 44 causes all of the data of the pair (coupling) of thumbnails generated for each pattern of replay forms to be stored in the thumbnail storage unit 52.

The association unit 45 associates the pair of replay target moving images selected by the image selection unit 43 with the pair of thumbnails generated by the thumbnail generation unit 44 corresponding thereto. It should be noted that, hereinafter, the association of the pair of replay target moving images with the pair of thumbnails is referred to as “first association”, in order to clearly distinguish from a positional relationship described later.

In addition to the first association, the association unit 45 further associates a spatial or temporal positional relationship when the pair of replay target moving images is displayed on the output unit 18. Such an association is hereinafter referred to as “second association”, in order to clearly distinguish from the first association.

The association unit 45 generates information indicating contents of the first association (hereinafter, referred to as “first association information”) and information indicating contents of the second association (hereinafter, referred to as “second association information”) and stores the information in the associated information storage unit 53.

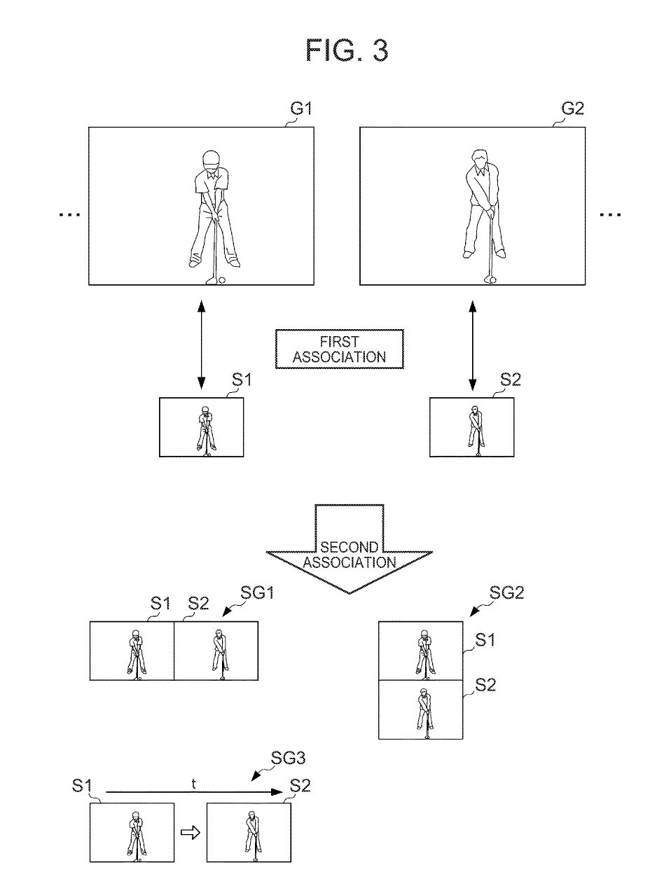

With reference to FIG. 3, the association unit 45 is further described in detail.

FIG. 3 is a schematic view showing a specific example of an association of a pair of replay target moving images with a pair of thumbnails.

As shown in FIG. 3, it is configured such that each of the n number (n is an integer greater than 1) of data sets such as moving images G1, G2 . . . Gn (n is a positive integer greater than or equal to 1) is stored in the image storage unit 51 and a pair of two moving images G1 and G2 from among these data sets is selected as a pair of replay target moving images by the image selection unit 43.

In this case, the thumbnail generation unit 44 generates each of data sets of a pair of thumbnails S1 and S2 for the pair of replay target moving images G1 and G2.

Next, the association unit 45 performs the first association of the pair (coupling) of two replay target moving images G1 and G2 with the pair of thumbnails S1 and S2 corresponding thereto so as to generate the first association information and store the information in the associated information storage unit 53.

Then, in addition to the first association, the association unit 45 performs the second association for a spatial or temporal positional relationship when the two replay target moving images G1 and G2 are displayed from the output unit 18. In the example of FIG. 3, a spatial positional relationship SG1, a spatial positional relationship SG2, and a temporal positional relationship SG3 are further associated by way of the second association, in addition to the first association.

The spatial positional relationship SG1 refers to a positional relationship in which the thumbnails S1 and S2 are arranged horizontally, i.e., a positional relationship indicating that the replay target moving images G1 and G2 can be arranged horizontally and the two screen simultaneous replay can be performed.

The spatial positional relationship SG2 refers to a positional relationship in which the thumbnails S1 and S2 are arranged vertically, i.e., a positional relationship indicating that the replay target moving images G1 and G2 are arranged vertically and the two screen simultaneous replay can be performed.

The temporal positional relationship SG3 refers to a temporal positional relationship in which the thumbnails S1 and S2 are replayed in its order, i.e., a positional relationship indicating that a sequential replay by the replay target moving images G1 and G2 can be performed.

With reference to FIG. 2 again, the execution unit 46 predetermined processing by automatically selecting the pair of replay target moving images thus associated in response to the operation on the pair of thumbnails to which association is performed by the association unit 45 (in the present embodiment, the first association and the second association).

Furthermore, specific examples of predetermined processing executed by the execution unit 46 are described with reference to FIGS. 4 to 7.

FIG. 4 illustrates an example of display of a pair of thumbnails on which the association of a spatial positional relationship is performed by the association unit 45.

When the first association is performed and then the second association of a spatial positional relationship is performed by the association unit 45, the execution unit 46 displays on the output unit 18 an image in which a plurality of pairs of thumbnails shown in FIG. 4 is included.

More specifically, with reference to the first association information, the execution unit 46 recognizes a pair of the replay target moving images G1 and G2 and also recognizes a pair of the thumbnails S1 and S2 corresponding thereto. Then, with reference to the second association information, the execution unit 46 recognizes a plurality of patterns of spatial positional relationships and arranges a pair of thumbnails S1 and S2 for each pattern recognized to display the pairs on the output unit 18.

For example, a pair ST1 of the thumbnails S1 and S2 is displayed on the output unit 18 according to the pattern of the spatial positional relationship SG1 of FIG. 3, i.e., the pattern in which the thumbnail S1 (the replay target moving image G1) is arranged at the left side and the thumbnail S2 (the replay target moving image G2) is arranged at the right side horizontally.

A pair ST2 of the thumbnails S1 and S2 is displayed on the output unit 18 according to the pattern of a spatial positional relationship (not illustrated in FIG. 3), i.e., the pattern in which the thumbnail S1 (the replay target moving image G1) is arranged at the left side and the thumbnail S2 (the replay target moving image G2) is arranged at the right side horizontally.

A pair ST3 of the thumbnails S1 and S2 is displayed on the output unit 18 according to the pattern of a spatial positional relationship SG2 of FIG. 3, i.e., the pattern in which the thumbnail S1 (the replay target moving image G1) is arranged at the upper side and the thumbnail S2 (the replay target moving image G2) is arranged at the lower side vertically.

A pair ST4 of the thumbnails S1 and S2 is displayed on the output unit 18 according to the pattern of a spatial positional relationship (not illustrated in FIG. 3), i.e., the pattern in which the thumbnail S1 (the replay target moving image G1) is arranged at the lower side and the thumbnail S2 (the replay target moving image G2) is arranged at the upper side vertically.

A pair ST5 of the thumbnails S1 and S2 is displayed on the output unit 18 according to the pattern of a spatial positional relationship (not illustrated in FIG. 3), i.e., the pattern in which the thumbnail S2 (replay target moving image G2) is displayed full-screen as a parent screen and the thumbnail S1 (replay target moving image G1) arranged to be superimposed on the parent screen as a child screen.

A pair ST6 of the thumbnails S1 and S2 is displayed on the output unit 18 according to the pattern of a spatial positional relationship (not illustrated in FIG. 3), i.e., the pattern in which the thumbnail S1 (replay target moving image G1) is displayed full-screen as a parent screen and the thumbnail S2 (replay target moving image G2) arranged to be superimposed on the parent screen as a child screen.

With such configurations in which the pairs from ST1 to ST6 of thumbnails S1 and S2 are displayed with a single view, it is possible for a user to easily image various patterns of spatial positional relationships among the display forms in which the two screen simultaneous replay is performed for the pair of replay target moving images G1 and G2.

Then, it is possible for the user to designate a desirable single pattern from among the various patterns of the spatial positional relationship in a case in which the two screen simultaneous replay is performed for the pair of replay target moving images G1 and G2 by operating the input unit 17 in a state in which the image shown in FIG. 4 is displayed on the output unit 18. More specifically, for example, the user operates the input unit 17 and designates a pair that is displayed in a desirable display form among the pairs from ST1 to ST6 of the thumbnails S1 and S2.

Then, the user operation reception unit 42 receives a designation result therefrom. The execution unit 46 executes the two screen simultaneous replay from the output unit 18 in a state in which the pair of replay target moving images G1 and G2 is arranged spatially according to a pattern of a spatial positional relationship specified from the designation result.

FIG. 5 is a schematic view illustrating that the two screen simultaneous replay is performed for a pair of replay target moving images G1 and G2 in a case in which a pair ST1 of the thumbnails S1 and S2 is selected.

In a case in which the pair ST1 of the thumbnails S1 and S2 of FIG. 4 is designated by the user, as shown in FIG. 5, according to the pattern of the spatial positional relationship SG1 of FIG. 3, the two screen simultaneous replay is performed from the output unit 18 in a state in which the replay target moving image G1 is arranged at the left side and the replay target moving image G2 is arranged at the right side horizontally.

FIG. 6 shows an example of display of a pair of thumbnails on which association of a temporal positional relationship is performed by the association unit 45.

When the first association is performed and then the second association of a temporal positional relationship is performed by the association unit 45, the execution unit 46 displays on the output unit 18 an image in which a plurality of pairs of thumbnails shown in FIG. 6 is included.

More specifically, with reference to the first association information, the execution unit 46 recognizes a pair of the replay target moving images G1 and G2 and also recognizes a pair of the thumbnails S1 and S2 corresponding thereto. Then, with reference to the second association information, the execution unit 46 recognizes a plurality of patterns of temporal positional relationships and schematically arranges a pair of thumbnails S1 and S2 for each pattern recognized to display the pairs on the output unit 18.

For example, a pair ST7 of the thumbnails S1 and S2 is schematically displayed on the output unit 18 according to the pattern of the temporal positional relationship SG3 of FIG. 3, i.e., the pattern in which the thumbnail S1 (the replay target moving image G1) is initially displayed and then the thumbnail S2 (the replay target moving image G2) is displayed thereafter.

A pair ST8 of the thumbnails S1 and S2 is schematically displayed on the output unit 18 according to the pattern of a temporal positional relationship (not illustrated in FIG. 3), i.e., the pattern in which the thumbnail S2 (the replay target moving image G2) is initially displayed and then the thumbnail S1 (the replay target moving image G1) is displayed thereafter.

With such configurations in which the pairs of ST7 and ST8 of thumbnails S1 and S2 are displayed, it is possible for a user to easily image various patterns of temporal positional relationships among the display forms in which the sequential display is performed for the pair of the replay target moving images G1 and G2 (a relationship of the order of replay therebetween).

Then, it is possible for the user to designate a desirable single pattern from among the various patterns of the temporal positional relationship in a case in which the sequential replay is performed for the pair of replay target moving images G1 and G2 by operating the input unit 17 in a state in which the image shown in FIG. 6 is displayed on the output unit 18. More specifically, for example, the user operates the input unit 17 and designates a pair that is displayed in a desirable display form between the pairs of ST7 and ST8 of the thumbnails S1 and S2.

Then, the user operation reception unit 42 receives a designation result therefrom. The execution unit 46 executes the sequential replay from the output unit 18 in a state in which the pair of replay target moving images G1 and G2 is arranged temporally, i.e., the order of the arrangement is set as a temporal order of replay, according to a pattern of a temporal positional relationship specified from the designation result.

It should be noted that the aspect ratio when the pair of thumbnails is displayed is not specifically limited. However, since the pair of replay target moving images corresponding to the pair of thumbnails is displayed full-screen on the output unit 18, the aspect ratio is similar to that of the output unit 18. Therefore, the aspect ratio of each of the two replay target moving images change according to the spatial or temporal positional relationship (refer to FIG. 5 or the like). Therefore, in light of a pair of thumbnails having an object to give the user an image of replay of a pair of the corresponding replay target moving images in advance, it is preferable that the overall aspect ratio of the pair of thumbnails is similar to that of the output unit 18.

FIG. 7 is a schematic view showing actual displays of a pair of thumbnails for each of spatial or temporal positional relationship.

In FIG. 7, regarding the pairs ST1 of thumbnails showing the two screen simultaneous replay arranged horizontally, the pairs ST3 of thumbnails showing the two screen simultaneous replay arranged vertically, and the pair ST7 of thumbnails showing the sequential replay, the overall aspect ratio thereof is similar to that of the output unit 18.

However, as a result of this, regarding the pair ST1 of thumbnails showing the two screen simultaneous replay arranged horizontally, the aspect ratio of each of the thumbnails S1 and S2 is reduced in the horizontal direction as compared to the output unit 18. On the other hand, regarding the pair ST3 of thumbnails showing the two screen simultaneous replay arranged vertically, the aspect ratio of each of the thumbnails S1 and S2 is reduced in the vertical direction as compared to the output unit 18. It should be noted that, regarding the pair ST7 of thumbnails showing the sequential replay, the aspect ratio of each of the thumbnails S1 and S2 is similar to that of the output unit 18.

Next, with reference to FIG. 8, thumbnail register processing executed by the image processing apparatus 1 having the functional configuration of FIG. 2 is described.

FIG. 8 is a flowchart showing a flow of the thumbnail register processing executed by the image processing apparatus 1 having the functional configuration of FIG. 2.

The thumbnail register processing starts when a user performs a predetermined operation on the input unit 17 and the following sequence of processing is executed.

In Step S11, the image selection unit 43 selects a pair of replay target moving images from among data of a plurality of moving images stored in the image storage unit 51.

In Step S12, the thumbnail generation unit 44 generates a pair of thumbnails by the number equal to patterns of spatial or temporal positional relationship, for the pair of replay target moving images selected in Step S11.

In Step S13, the association unit 45 generates information of association of the pair of replay target moving image with the pair of thumbnails (in the present embodiment, the first association information and the second association information) and registers (stores) the information in the associated information storage unit 53.

In Step S14, the association unit 45 registers (stores) the pairs of thumbnails of which the number corresponds to patterns of replay forms of the pairs of replay target moving images generated in Step S12 (patterns of spatial or temporal positional relationship) in the thumbnail storage unit 52.

Then, the thumbnail register processing ends.

When the thumbnail register processing ends, an image including each of the pairs of thumbnails registered displayed with a single view (for example, images shown in FIG. 4 or 6) is displayed on the output unit 18. It is possible for the user to designate the pair of thumbnails in a desirable display form by operating the input unit 17 while viewing the image. When this designation operation is received by the user operation reception unit 42 and notified to the execution unit 46, the replay processing shown in FIG. 9 starts.

FIG. 9 is a flowchart showing a flow of replay processing executed by the image processing apparatus 1 having the functional configuration of FIG. 2.

In Step S31, the execution 46 selects a pair of thumbnails according to contents of the designation operation received by the user operation reception unit 42.

In Step S32, the execution unit 46 searches the pair of replay target moving images that is associated with the pair of thumbnails selected in Step S31 based on the first association information stored in the associated information storage unit 53.

In Step S33, the execution unit 46 reads each of data sets of the pair of replay target moving images searched in Step S32 from the image storage unit 51.

In Step S34, the execution unit 46 starts replay of the pair of replay target moving images read in Step S33 with a spatial or temporal positional relationship that is associated with the pair of thumbnails selected in Step S31 based on the second association information stored in the associated information storage unit 53.

In Step S35, the execution unit 46 judges whether the replay of the pair of replay target moving images has ended.

If the replay of the pair of replay target moving images has not ended, it is judged as NO in Step S35, and the processing returns to Step S35. In other words, the judgment processing of Step S35 is executed repeatedly until the replay of the pair of replay target moving images ends, and the replay processing enters the standby state.

When the replay of the pair of replay target moving images ends, it is judged as YES in Step S35 and the replay processing ends.

The first embodiment is described above. Then, a second embodiment is described below.

### Second Embodiment

An image processing apparatus 1 according to a second embodiment can adopt a hardware configuration that is basically similar to the hardware configuration according to the first embodiment. Therefore, FIG. 1 also shows a block diagram showing a hardware configuration of the image processing apparatus 1 according to the second embodiment.

Furthermore, the image processing apparatus 1 according to the second embodiment can basically adopt a functional configuration similar to the functional configuration of the image processing apparatus 1 according to the first embodiment.

However, regarding thumbnail register processing, although the thumbnail generation unit 44 generates the pair of thumbnails for all of the positional relationships that can be combined in the first embodiment, in the second embodiment, only pairs of thumbnails of positional relationships that are selected is generated.

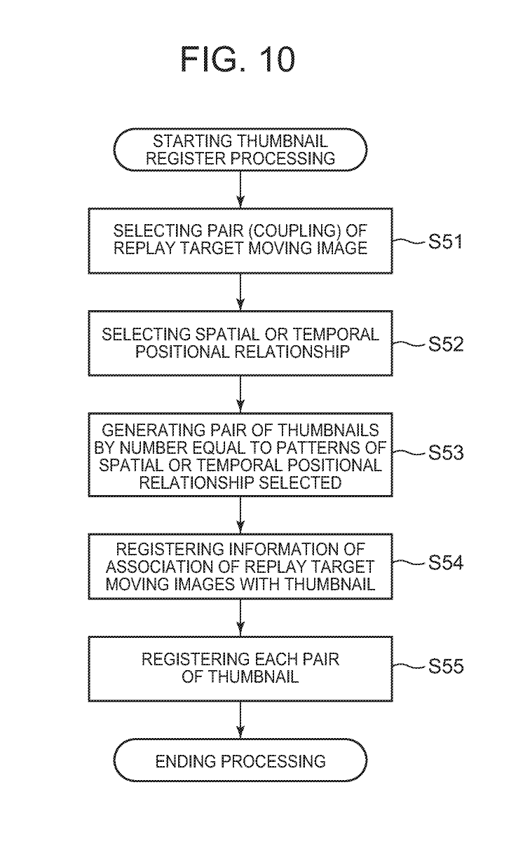

Therefore, in the second embodiment, thumbnail register processing of FIG. 10 is executed in place of the thumbnail register processing of FIG. 8.

FIG. 10 is a flowchart showing a flow of thumbnail register processing according to the second embodiment executed by the image processing apparatus 1 having the functional configuration of FIG. 2.

In Step S51, the image selection unit 43 selects a pair of replay target moving images from among data of a plurality of moving images stored in the image storage unit 51.

In the second embodiment, it is possible for a user to designate one or more desirable positional relationship by operating the input unit 17. When the designation operation is received by the user operation reception unit 42 and notified to the image selection unit 43, the processing advances to Step S52.

In Step S52, the image selection unit 43 selects one or more spatial or temporal positional relationship based on contents of the designation operation received by the user operation reception unit 42.

In Step S53, the thumbnail generation unit 44 generates a pair of thumbnails by the number equal to patterns of spatial or temporal positional relationship selected in Step S52, for the pair of replay target moving images selected in Step S51.

In Step S54, the association unit 45 generates information of association of the pair of replay target moving image with the pair of thumbnails (in the present embodiment, the first association information and the second association information) and registers (stores) the information in the associated information storage unit 53.

In Step S55, the association unit 45 registers (stores) the pairs of thumbnails of which the number corresponds to patterns of selected replay forms of the pairs of replay target moving images generated in Step S53 (patterns of spatial or temporal positional relationship selected) in the thumbnail storage unit 52.

Then, the thumbnail register processing ends. The second embodiment is described above. Then, a third embodiment is described below.

### Third Embodiment

An image processing apparatus 1 according to a third embodiment can adopt a hardware configuration that is basically similar to the hardware configuration according to the first embodiment. Therefore, FIG. 1 also shows a block diagram showing a hardware configuration of the image processing apparatus 1 according to the third embodiment.

Furthermore, the image processing apparatus 1 according to the third embodiment can basically adopt a functional configuration similar to the functional configuration of the image processing apparatus 1 according to the first embodiment.

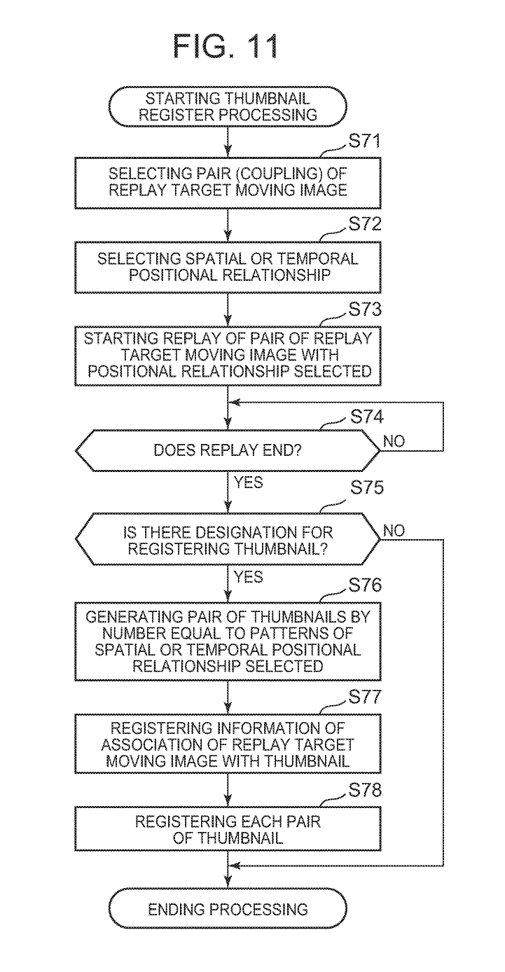

However, regarding thumbnail register processing, the thumbnail generation unit 44 generates the pair of thumbnails for all of the positional relationships that can be combined in the first embodiment. On the other hand, in thumbnail register processing according to the third embodiment, the thumbnail generation unit 44 only generates pairs of thumbnails of positional relationships that are displayed. Therefore, in the third embodiment, thumbnail register processing of FIG. 11 is executed in place of the thumbnail register processing of FIG. 8.

FIG. 11 is a flowchart showing a flow of thumbnail register processing according to the third embodiment executed by the image processing apparatus 1 having the functional configuration of FIG. 2.

In Step S71, the image selection unit 43 selects a pair of replay target moving images from among data of a plurality of moving images stored in the image storage unit 51.

In the second embodiment, it is possible for a user to designate a desirable positional relationship by operating the input unit 17. When the designation operation is received by the user operation reception unit 42 and notified to the image selection unit 43, the processing advances to Step S72.

In Step S72, the image selection unit 43 selects a spatial or temporal positional relationship based on contents of the designation operation received by the user operation reception unit 42.

In Step S73, the execution unit 46 starts replay of the pairs of replay target moving images selected in Step S71 with the spatial or temporal positional relationship selected in Step S72.

In Step S74, the execution unit 46 judges whether the replay of the pair of replay target moving images has ended.

If the replay of the pair of replay target moving images has not ended, it is judged as NO in Step S74, and the processing returns to Step S74. In other words, the judgment processing of Step S74 is executed repeatedly until the replay of the pair of replay target moving images ends, and the thumbnail register processing enters the standby state.

When the replay of the pair of replay target moving images ends, it is judged as YES in Step S75 and the replay processing ends.

In Step S75, the user operation reception unit 42 judges whether there is a designation for thumbnail register by an operation of a user on the input unit 17.

If the user does not desire the thumbnail register and thus does not operate a designation operation of register, it is judged as NO in Step S75 and the thumbnail register processing ends.

On the other hand, if the user desires the thumbnail register and operates a designation operation of register, it is judged as YES in Step S75 and the processing advances to Step S75.

In Step S76, the thumbnail generation unit 44 generates a pair of thumbnails by the number equal to patterns of spatial or temporal positional relationship selected in Step S71, for the pair of replay target moving images selected in Step S72.

In Step S77, the association unit 45 generates information of association of the pair of replay target moving image with the pair of thumbnails (in the present embodiment, the first association information and the second association information) and registers (stores) the information in the associated information storage unit 53.

In Step S78, the association unit 45 registers (stores) the pairs of thumbnails of which the number corresponds to patterns of selected replay forms of the pairs of replay target moving images generated in Step S76 (patterns of spatial or temporal positional relationship selected) in the thumbnail storage unit 52.

Then, the thumbnail register processing ends.

As described above, the image processing apparatus 1 according to the present embodiment includes: the image selection unit 43, the thumbnail generation unit 44, the association unit 45, and the execution unit 46.

The image selection unit 43 selects a pair consisting of a plurality of images as targets for predetermined processing. The thumbnail generation unit 44 generates a thumbnail that can identify the pair consisting of a plurality of images that is selected by the image selection unit 43. The association unit 45 associates predetermined information indicating the pair consisting of a plurality of images selected by the image selection unit 43 (for example, the first association information as describe above) with the thumbnail generated by the thumbnail generation unit 44. The execution unit 46, in response to an operation on the thumbnail associated by the association unit 45, executes predetermined processing by automatically selecting a pair consisting of a plurality of images indicated with predetermined information that is associated with the thumbnail.

With such a configuration, by the user simply selecting a thumbnail that can identify which image is associated with, an image associated is automatically selected, and thus predetermined processing is automatically executed. As a result, it becomes possible to save the user's operation when processing such as selecting a plurality of images.

Furthermore, the association unit 45 of the image processing apparatus 1 according to the present embodiment associates a plurality of thumbnails generated by the thumbnail generation unit 44 with predetermined information indicating the pair consisting of the plurality of images and stores the thumbnails with which the predetermined information is associated.

The execution unit 46 executes predetermined processing in response to a selection operation on a plurality of thumbnails stored by the association unit 45.

With such a configuration, by the user simply selecting a desired one from among a plurality of thumbnails stored, a pair consisting of images associated with the thumbnail selected, and thus predetermined processing is automatically executed. As a result, it becomes possible to save the user's operation when processing such as selecting a plurality of images.

Furthermore, the association unit 45 of the image processing apparatus 1 according to the present embodiment further associates a spatial or temporal positional relationship upon performing predetermined processing with the pair consisting of the plurality of images. The thumbnail generation unit 44 further generates a thumbnail that can also identify a spatial or temporal positional relationship. Then, the execution unit 46, in response to the operation on the thumbnail included in the association, the execution section automatically selects a pair consisting of a plurality of images that is associated and executes predetermined processing with a positional relationship that is associated.

With such a configuration, by the user simply selecting a thumbnail that can identify a positional relationship in which images are associated, the images associated are automatically selected, and thus predetermined processing is automatically executed.

Furthermore, the spatial or temporal positional relationship associated by the association unit 45 of the image processing apparatus 1 according to the present embodiment is a positional relationship upon displaying each of a plurality of images separately on a plurality of screens.

With such a configuration, it becomes possible for the user to automatically select a plurality of images as well as positional relationships when displaying a plurality of images on a plurality of screens easily.

Furthermore, the spatial or temporal positional relationship associated by the association unit 45 of the image processing apparatus 1 according to the present embodiment is a positional relationship upon displaying a plurality of images so as to be superimposed within a single screen.

With such a configuration, it becomes easy for the user to automatically select a plurality of images as well as positional relationships when displaying a plurality of images so as to be superimposed within a single screen.

Furthermore, the spatial or temporal positional relationship associated by the association unit 45 of the image processing apparatus 1 according to the present embodiment is a positional relationship upon displaying a plurality of images so as to be superimposed within a single screen.

With such a configuration, it becomes easy for the user to automatically select a plurality of images as well as positional relationships when displaying a plurality of images so as to be superimposed within a single screen.

The thumbnail generation unit 44 of the image processing apparatus 1 according to the present embodiment generates, as a thumbnail, a reduced image that is prepared by arranging the pair consisting of the plurality of images selected with a predetermined positional relationship that can be combined corresponding to the spatial or temporal positional relationship and that is composited as such.

With such a configuration, it becomes unnecessary for the user to select a positional relationship and it becomes possible for the user to freely select and display a positional relationship of images.

Furthermore, the thumbnail generation unit 44 of the image processing apparatus 1 according to the present embodiment generates, as a thumbnail, a reduced image that is prepared by arranging the pair consisting of the plurality of images selected by selecting a positional relationship in which the spatial or temporal positional relationship can be combined and that is composited as such.

With such a configuration, since only thumbnails of combination necessary are generated, it becomes possible to prevent unnecessary thumbnails from increasing unnecessarily.

Furthermore, the thumbnail generation unit 44 of the image processing apparatus 1 according to the present embodiment generates, as a thumbnail, a reduced image that is prepared by arranging the pair consisting of a plurality of images based on a positional relationship displayed and that is composited as such, after executing display of the pair consisting of the plurality of images.

With such a configuration, since only thumbnails displayed are generated, it is possible for the user to generate thumbnails upon checking the display, a result of which it becomes possible to prevent unnecessary thumbnails from increasing unnecessarily.

The predetermined processing executed by the execution unit 46 of the image processing apparatus 1 according to the present embodiment is to display each of a plurality of images separately on a plurality of screens.

With such a configuration, it becomes possible for the user to select automatically a plurality of images when displaying a plurality of images on a plurality of screens easily.

Furthermore, the predetermined processing executed by the execution unit 46 of the image processing apparatus 1 according to the present embodiment is to display a plurality of images so as to be superimposed within a single screen.

With such a configuration, it becomes possible for the user to automatically select a plurality of images upon displaying a plurality of images so as to be superimposed within a single screen.

Furthermore, the predetermined processing executed by the execution unit 46 of the image processing apparatus 1 according to the present embodiment is to display a plurality of images by sequentially switching the plurality of images within a single screen.

With such a configuration, it becomes possible for the user to automatically select a plurality of images upon displaying a plurality of images by sequentially switching the plurality of images within a single screen.

The thumbnail generation unit 44 of the image processing apparatus 1 according to the present embodiment generates the thumbnail by coupling each of the plurality of images.

With such a configuration, it becomes possible for the user to easily identify a plurality of images.

Furthermore, the image processing apparatus 1 according to the present embodiment includes: the image selection unit 43; the thumbnail generation unit 44, the association unit 45, and the execution unit 46.

The image selection unit 43 selects a pair of spatial or temporal positional relationships consisting of a plurality of images as targets for predetermined processing.

The thumbnail generation unit 44 generates a thumbnail that can identify the pair of spatial or temporal positional relationships consisting of a plurality of images selected by the selection unit 43.

The association unit 45 associates predetermined information indicating the pair of spatial or temporal positional relationships consisting of a plurality of images selected by the image selection unit 43 with the thumbnail generated by the thumbnail generation unit 44.

The execution unit 46, in response to an operation on the thumbnail associated by the association unit 45, executes predetermined processing by automatically selecting the pair of spatial or temporal positional relationships consisting of a plurality of images indicated with predetermined information that is associated with the thumbnail.

With such a configuration, by the user simply selecting a thumbnail that can identify a positional relationship in which images are associated, the pair consisting of a plurality of images associated with the thumbnails selected is automatically selected, and thus predetermined processing is automatically executed with the positional relationship associated. With such a configuration, it becomes possible to save the user's operation when processing such as selecting a plurality of images.

It should be noted that the present invention is not to be limited to the aforementioned embodiment, and that modifications, improvements, etc. within a scope that can achieve the object of the present invention are also included in the present invention.

In the embodiments above, although the number of moving images belonging to the pair of replay target moving images is two, the present invention is not limited thereto. For example, the image selection unit 43 can select three or more moving images as a group of replay target moving images in a case in which three or more moving images are designated based on a user's operation.

In this case, since a group of three or more thumbnails is made, a spatial or temporal positional relationship includes a combination including three or more patterns, a result of which the number of screens for which a spatial or temporal positional relationship is selected changes according to the number of the group as compared to the case of two or the screen of FIG. 4 or 6.

Furthermore, although, in the abovementioned embodiment, the two screen simultaneous replay is performed for the two replay target moving images on a single display of the output unit 18, the present invention is not limited thereto, and thus, for example, multi-screen simultaneous replay can be performed for a plurality of replay target moving images on a plurality of displays of the output unit 18.

Furthermore, although, in the abovementioned embodiment, the association unit 45 associates the spatial or temporal positional relationship when displaying a plurality of images selected by the image selection unit 43 on the output unit 18, the target of association is not limited thereto. For example, the association unit 45 can assign either a main sound or a supplementary sound as a sound for a replay target moving images and associate contents thus assigned with a thumbnail.

Furthermore, although, in the abovementioned embodiment, it is configured that the thumbnails are displayed by sequentially switching on a single screen, the present invention is not limited thereto. For example, an interval for display by sequentially switching thumbnails is not specifically limited to an overall interval. For example, the overall interval can be divided into two intervals, such as a first thumbnail of a first interval and a second thumbnail of the first interval, and a first interval of a second interval and a second interval of the second interval. Therefore, it may be configured such that the thumbnails are switched with a regular pattern. It can be configured such that the configuration may change depending on thumbnails shown.

Furthermore, although, in the abovementioned embodiment, it is configured that an image for replay target is a moving image, the present invention is not limited thereto. For example, an aggregate of a plurality of static images produced by so-called continuous shooting or a static image describing a momentary form of golf swing may be adopted as an image for replay target.

Furthermore, although, in the abovementioned embodiment, it is configured that the overall image is secured by changing the aspect ratio upon replay of spatial or temporal positional relationships or generation of thumbnails, it may be configured to trim the image while keeping the aspect ratio as-is.

Furthermore, since the generation of thumbnails and the association of positional relationships are temporary matters for facilitating the selection of positional relationships of images, the matters may not be stored.

In the aforementioned embodiments, the digital camera has been described as an example of the image processing device 1 to which the present invention is applied, but the present invention is not limited thereto in particular.

For example, the present invention can be applied to any electronic device in general having a display function. More specifically, for example, the present invention can be applied to a lap-top personal computer, a printer, a television, a video camera, a portable navigation device, a smart phone, a cell phone device, a portable gaming device, and the like.

The processing sequence described above can be executed by hardware, and can also be executed by software.

In other words, the hardware configuration shown in FIG. 2 is merely an illustrative example, and the present invention is not particularly limited thereto. More specifically, the types of functional blocks employed to realize the above-described functions are not particularly limited to the example shown in FIG. 2, so long as the image processing device 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 19 shown in FIG. 1 or the like, in which the program is recorded.

It should be noted that, in the present specification, the steps describing the program recorded in the storage medium include not only the processing executed in a time series following this order, but also processing executed in parallel or individually, which is not necessarily executed in a time series.

In addition, in the present specification, a term system shall mean a general device configured from a plurality of devices, a plurality of means, and the like.

Although some embodiments of the present invention have been described above, the embodiments are merely exemplification, and do not limit the technical scope of the present invention. Other various embodiments can be employed for the present invention, and various modifications such as omission and replacement are possible without departing from the spirits of the present invention. Such embodiments and modifications are included in the scope of the invention and the summary described in the present specification, and are included in the invention recited in the claims as well as the equivalent scope thereof.

While the present invention has been described with reference to the preferred embodiments, it is intended that the invention be not limited by any of the details of the description therein but includes all the embodiments which fall within the scope of the appended claims.

What is claimed is:

1. An image processing apparatus comprising:
at least one display; and
a CPU that is configured to:
select, as a group, a plurality of moving images as a group of target moving images to be played back simultaneously or in sequence;
specify a plurality of spatial or temporal playback relationships for playing back the group of target moving images simultaneously or in sequence;
generate a plurality of groups of thumbnails representing the plurality of specified spatial or temporal playback relationships, such that each group of thumbnails includes one thumbnail corresponding to each of the target moving images to be played back, and such that each group of thumbnails visually represents a respective one of the specified the spatial or temporal playback relationships;
associate information with each of the groups of thumbnails, such that for each of the groups of thumbnails, the associated information associate the group of thumbnails with the target moving images and with the spatial or temporal playback relationship visually represented by the group of thumbnails;
display the plurality of groups of thumbnails representing the plurality of specified spatial or temporal playback relationships; and
in response to a designation of one of the displayed groups of thumbnails, play back the group of target moving images with the spatial or temporal playback relationship visually represented by the designated group of thumbnails, based on the information associated with the designated group of thumbnails.

2. The image processing apparatus according to claim 1, wherein the CPU automatically specifies, as the specified plurality of spatial or temporal playback relationships, all of a preset group of spatial or temporal playback relationships.

3. The image processing apparatus according to claim 2, wherein the preset group of spatial or temporal playback relationships includes at least two spatial or temporal playback relationships selected from the group consisting of: (i) horizontally aligned side-by-side simultaneous playback of the target moving images, (ii) vertically aligned side-by-side simultaneous playback of the target moving images, (iii) superimposed simultaneous playback of the target moving images, and (iv) sequential playback of the target moving images.

4. The image processing apparatus according to claim 1, wherein the CPU specifies the plurality of spatial or temporal playback relationships based on a user operation.

5. The image processing apparatus according to claim 4, wherein the CPU specifies the plurality of spatial or temporal playback relationships based on a user selection from a preset group of spatial or temporal playback relationships.

6. The image processing apparatus according to claim 5, wherein the preset group of spatial or temporal playback relationships includes at least two spatial or temporal playback relationships selected from the group consisting of: (i) horizontally aligned side-by-side simultaneous playback of the target moving images, (ii) vertically aligned side-by-side simultaneous playback of the target moving images, (iii) superimposed simultaneous playback of the target moving images, and (iv) sequential playback of the target moving images.

7. The image processing apparatus according to claim 1, wherein the plurality of spatial or temporal playback relationships includes horizontally aligned side-by-side simultaneous playback of the target moving images, and the CPU is configured to automatically alter an aspect ratio of each of the thumbnails in the group of thumbnails corresponding to the horizontally aligned side-by-side simultaneous playback of the target moving images such that an overall aspect ratio of the group of thumbnails corresponds to an aspect ratio of the display.

8. The image processing apparatus according to claim 1, wherein the plurality of spatial or temporal playback relationships includes vertically aligned side-by-side simultaneous playback of the target moving images, and the CPU is configured to automatically alter an aspect ratio of each of the thumbnails in the group of thumbnails corresponding to the vertically aligned side-by-side simultaneous playback of the target moving images such that an overall aspect ratio of the group of thumbnails corresponds to an aspect ratio of the display.

9. The image processing apparatus according to claim 1, wherein the plurality of spatial or temporal playback relationships include sequential playback of the target moving images, and the CPU is configured to generate the group of thumbnails corresponding to the sequential playback of the target moving images such that each thumbnail in the group of thumbnails has an aspect ratio corresponding to an aspect ratio of the display.

10. An image processing method executed by an image processing apparatus including a display, the method comprising:
selecting, as a group, a plurality of moving images as a group of target moving images to be played back simultaneously or in sequence;
specifying a plurality of spatial or temporal playback relationships for playing back the group of target moving images simultaneously or in sequence;
generating a plurality of groups of thumbnails representing the plurality of specified spatial or temporal playback relationships, such that each group of thumbnails includes one thumbnail corresponding to each of the target moving images to be played back, and such that each group of thumbnails visually represents a respective one of the specified the spatial or temporal playback relationships;
associating information with each of the groups of thumbnails, such that for each of the groups of thumbnails, the associated information associate the group of thumbnails with the target moving images and with the spatial or temporal playback relationship visually represented by the group of thumbnails;
displaying the plurality of groups of thumbnails representing the plurality of specified spatial or temporal playback relationships; and
in response to a designation of one of the displayed groups of thumbnails, playing back the group of target moving images with the spatial or temporal playback relationship visually represented by the designated group of thumbnails, based on the information associated with the designated group of thumbnails.

11. A non-transitory storage medium encoded with a computer-readable program that enables a computer to execute functions comprising:
specifying a plurality of spatial or temporal playback relationships for playing back the group of target moving images simultaneously or in sequence;
generating a plurality of groups of thumbnails representing the plurality of specified spatial or temporal playback relationships, such that each group of thumbnails includes one thumbnail corresponding to each of the target moving images to be played back, and such that each group of thumbnails visually represents a respective one of the specified the spatial or temporal playback relationships;
associating information with each of the groups of thumbnails, such that for each of the groups of thumbnails, the associated information associate the group of thumbnails with the target moving images and with the spatial or temporal playback relationship visually represented by the group of thumbnails;
displaying the plurality of groups of thumbnails representing the plurality of specified spatial or temporal playback relationships; and
in response to a designation of one of the displayed groups of thumbnails, playing back the group of target moving images with the spatial or temporal playback relationship visually represented by the designated group of thumbnails, based on the information associated with the designated group of thumbnails.
